(19) United States
(12) Patent Application Publication
(10) Pub. No.: US 2011/0083962 A1
(43) Pub. Date: Apr. 14, 2011

(54) ADSORPTION PREVENTION METHOD OF INNER-WALL-COATED CAPILLARY FOR CAPILLARY ELECTROPHORESIS, INNER-WALL-COATED CAPILLARY FOR CAPILLARY ELECTROPHORESIS, MANUFACTURING METHOD THEREOF, AND METHOD FOR SIMULTANEOUS ANALYSIS OF PHOSPHORYLATED COMPOUND AND ANION BY CAPILLARY ELECTROPHORESIS

(75) Inventors: Yasushi Ishihama, Tsuruoka-shi (JP); Maria R. N. Monton, Yamagata (JP)

(73) Assignee: KEIO UNIVERSITY, Tokyo (JP)

(21) Appl. No.: 12/993,343

(22) PCT Filed: May 22, 2009
(86) PCT No.: PCT/JP2009/059436

§ 371 Date: Nov. 18, 2010

(30) Foreign Application Priority Data
May 22, 2008 (JP) 2008-134494

(51) Int. Cl. G01N 27/447; B05D 7/22

(52) U.S. Cl. 204/451; 204/601; 427/230

(57) ABSTRACT

A inner-wall-coated capillary in which a zwitterionic polymer including a phosphate group including, for example, a phosphorylcholine group, is fixed on a wall surface including, for example, silanol by ionic interaction, is obtained by flowing a polymer solution including a phospholipid polymer combining, for example, MPC and BMA or MPC and SMA, through a capillary that includes silanol on the wall surface, for example. Consequently, adsorption of phosphorylated compounds can be prevented simply and highly durably.

### TECHNICAL FIELD

The present invention relates to an adsorption prevention method, an adsorption prevention material, an inner-wall-coated capillary, a manufacturing method thereof, and a method for simultaneous analysis of a phosphorylated compound and anion. More particularly, the present invention relates to an adsorption prevention method that is highly durable and that can simply prevent adsorption of a phosphorylated compound on an inner wall of a fused silica capillary used in capillary electrophoresis and the like, an adsorption prevention material, an inner-wall-coated capillary that has been subjected to an adsorption prevention treatment, manufacturing method thereof, and a method for simultaneous analysis of a phosphorylated compound and anion that uses the above inner-wall-coated capillary.

### BACKGROUND ART

Capillary electrophoresis (CE) is the common term for electrophoresis carried out in a capillary tube having an inner diameter of 100 μm or less. Since capillary electrophoresis has characteristics such as a very high separation power, a high-speed performance, and a micro-scale, it is used in a wide range of fields, such as DNA sequencing, and food and drug analysis.

Recently, as described in Japan Patent No. 3038184 (hereinafter, “Patent Document 1”), additional applied research is being carried out, such as using CE-ME that is directly coupled with a mass spectrometer (MS) in a metabolome analysis system.

Although fused silica is usually used for the capillary tube used in separation, depending on the sample adsorption resulting from the silanol groups on the wall surface is known to occur. This can not only cause distortion in the peak shape and deterioration in the separation efficiency, but also render quantitative analysis impossible.

Various inner-wall-coated capillaries have so far been developed and commercially available, such as a capillary in which a hydrophilic polymer is covalently bonded or physically adhered.

The inner-wall-coated capillary (hereinafter, referred to as “SMILE-coated capillary”) described in Japanese Patent Application Laid-Open No. Hei. 10-221305 (hereinafter, “Patent Document 2”), which was co-invented by one of the present inventors, is the only commercially-available capillary that is coated with a polymer having a positive charge, and has thus become an essential tool in metabolome analysis (anion analysis) using CE-MS.

In addition, one of the reasons for the development of the inner-wall-coated capillary (hereinafter, referred to as “KEIO-coated capillary”) described in Japanese Patent Application Laid-Open No. 2008-32397 (hereinafter, “Patent Document 3”), which was co-invented by two of the inventors of the present invention, was also for metabolome analysis (anion analysis) using CE-MS.

On the other hand, Japanese Patent Application Laid-Open No. 2007-22886 (hereinafter, “Patent Document 4”), Jiang. et al., Journal of Chromatography A, 1127 (2006) 82-91 (hereinafter, “Non-Patent Document 1”), and Xu. at al., Lab Chip, 2007, 7, 119-206 (hereinafter, “Non-Patent Document 2”) describe fixing of a phospholipid type polymer to silica gel and/or microchip inner wall.

However, conventional inner-wall-coated capillaries suffer from many problems, such as having poor stability, or lot differences. Further, from a cost perspective as well, conventional inner-wall-coated capillaries are not suited for practical analysis.

The SMILE-coated capillary proposed in Patent Document 2 realized the best stability and durability at that time, by alternately adhering a polymer having a positive charge and a polymer having a negative charge rather than by coating by a chemical reaction having poor reproducibility. However, unfortunately, because the nature of the polymer supplied from the reagent manufacturer dramatically changed, the durability of the capillaries currently sold commercially has deteriorated, so that these capillaries can only be used in analysis a few dozen times.

Further, the KEIO-coated capillary proposed in Patent Document 3 was developed by a novel method which, rather than fixing the polymer to be coated itself, fixed the polymer to be coated while entangling the polymer with a silica film produced inside the capillary. Although the KEIO-coated capillary exhibits a superior performance to that of the SMILE-coated capillary described in Patent Document 2, concerning analysis of a compound having a phosphate group, the KEIO-coated capillary was found to suffer from interaction with the inner wall, so that application of quantitative analysis was difficult.

On the other hand, fixing method of phospholipid type polymer to silica gel and/or microchip inner wall described in Patent Document 4 and Non-Patent Documents 1 and 2 perform fixing via a covalent bond by introducing a functional group in advance for performing a silylation reaction in the polymer. Consequently, processing is complicated. In addition, application of such a method is directed to separation carriers for hydrophilic interaction chromatography in order to prevent protein adsorption and peptide separation. No applications for phosphorylated compounds have been reported.

Many techniques have been tried for fixing various compounds on a capillary. Although there is a technique for coating a phospholipid on a capillary or a silica gel, the coating strength is weak, and can at best be described as a semi-permanent coating. Thus, until now, there have been no techniques which try to fix a zwitterionic polymer including a phosphate group only by ionic interaction.

### DISCLOSURE OF THE INVENTION

The present invention was devised in order to resolve the above-described problems in the conventional art. It is an object of the present invention to prevent adsorption of phosphorylated compounds simply and highly durably.

The present invention resolves the above-described problems by preventing adsorption of a phosphorylated compound using an amphoteric ionic polymer that is lipid-soluble.

A phospholipid polymer may be used for the above polymer.

Examples of this phospholipid polymer include a polymer combining 2-methacryloyloxyethyl phosphorylcholine (MPC) and stearylmethacrylate (SMA), and a polymer combining MPC and n-butylmethacrylate (BMA).

The present invention also provides an adsorption prevention material, characterized by including the above-described polymer.

The present invention also provides an inner-wall-coated capillary, characterized in that the above-described polymer is fixed to a wall surface by ionic interaction.

This wall surface may include silanol.

The present invention also provides a method for manufacturing the above-described inner-wall-coated capillary, characterized by flowing a polymer solution including the above-described polymer through a capillary.

The present invention also provides a method for simultaneous analysis of a phosphorylated compound and anion, characterized by using the above-described inner-wall-coated capillary.

According to the present invention, highly durable and simple adsorption prevention of phosphorylated compounds can be achieved. Here, as the phosphorylated compound serving as the analysis target, a compound having a molecular weight that is smaller than an oligonucleotide but larger than an inorganic compound is preferred.

The inner-wall-coated capillary developed in the present invention fixes a zwitterionic type polymer. The fixing method is a simple method, of just passing a polymer solution through a capillary, and has very high analysis reproducibility.

Further, the inventive inner-wall-coated capillary also enables quantitative analysis of phosphorylated compounds, which has been impossible with conventional cationic polymer fixed capillaries, as well as enabling simultaneous analysis of anionic metabolome samples.

### BRIEF DESCRIPTION OF THE DRAWINGS

FIG. 1 is a cross-sectional view illustrating a configuration of an embodiment of an inner-wall-coated capillary according to the present invention.

FIG. 2 is an enlarged perspective view illustrating a part of an inner wall surface of the same.

FIG. 3 is a flow diagram illustrating a manufacturing sequence of the inner-wall-coated capillary according to the present invention.

FIG. 4 illustrates types of phospholipid polymers.

FIG. 5 illustrates the analysis results of an anion mixture by a polymer B-coated capillary according to the present invention.

FIG. 6 illustrates the analysis results of a nucleotide mixture by the same.

FIG. 7 illustrates the analysis results of a nucleotide mixture by a polymer C-coated capillary according to the present invention.

FIG. 8 shows the comparison of the stability of inner-wall-coated capillaries.

FIG. 9 is a diagram illustrating the comparison of durability against organic solvents.

FIG. 10 illustrates the analysis results of a mixture containing an anion and a nucleotide by the polymer B-coated capillary according to the present invention.

### BEST MODE FOR CARRYING OUT THE INVENTION

An embodiment of the present invention will now be described in more detail with reference to the drawings.

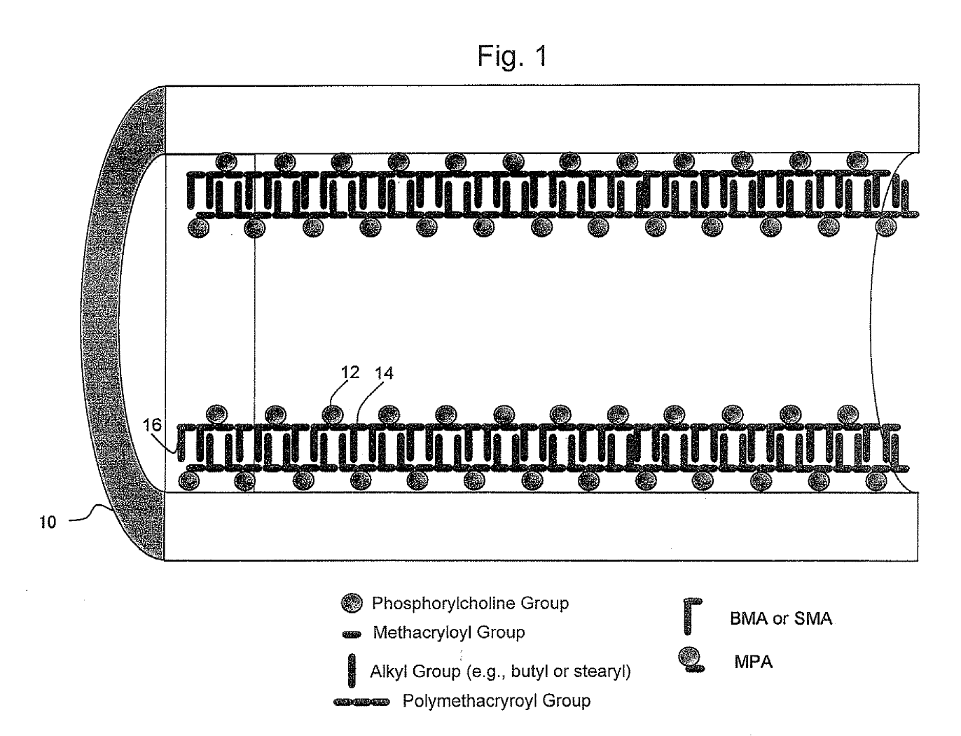

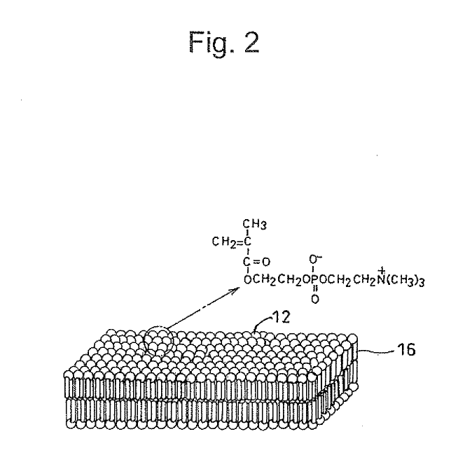

In the present embodiment, as illustrated in FIG. 1 (schematic view) and FIG. 2 (partial enlarged perspective view), a zwitterionic polymer including a phosphate group comprising, for example, a phosphorylcholine group 12, is fixed by ionic interaction by flowing a phospholipid polymer comprising, for example, MPC and BMA or MPC and SMA, through the inside of a capillary 10 made from fused silica as in the conventional art. In the drawings, reference numeral 14 denotes a polymethacryroyl group, and reference numeral 16 denotes an alkyl group such as butyl (for BMA) or stearyl (for SMA).

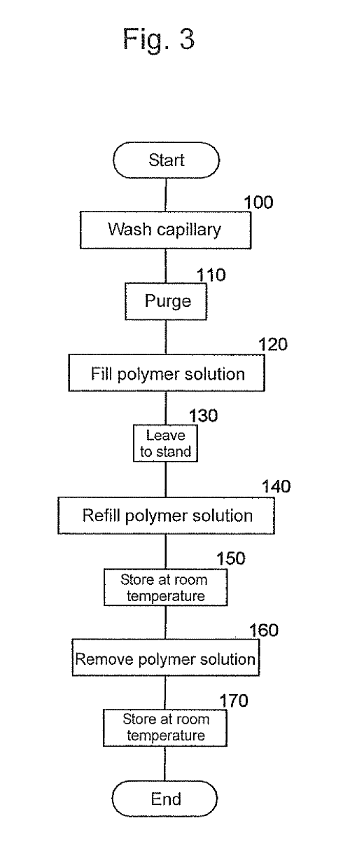

During coating, when coating a polymer on the fused silica capillary 10 having, for example, a length of 120 cm and an inner diameter of 50 μm, first, as illustrated in FIG. 3, the capillary 10 is pre-washed for 15 minutes with 1 N NaOH, and then for 15 minutes with distilled water in step 100. Then, in step 110, the capillary 10 is purged with nitrogen for 15 minutes.

Next, in step 120, using a 1 mL syringe, for example, a polymer solution is filled into the capillary 10. At this stage, the discharge of several dozen droplets from the tip is confirmed, for example.

Then, in step 130, the capillary 10 is left for 10 minutes. Subsequently, in step 140, the operation in step 120 is carried out again.

Next, in step 150, the capillary 10 is stored for 1 hour at room temperature.

Then, in step 160, the capillary 10 is purged with air to remove excess polymer solution therefrom.

Next, in step 170, the capillary 10 is stored overnight at room temperature, and the coating process is finished.

The present embodiment completes fixation just by passing a solution. Further, the present embodiment can realize a high analysis reproducibility for a practical sample nearly 100 times. This is thought to be due to both the electrostatic interaction between the silanols having a negative charge and the choline ammonium groups present in the polymer, and the interaction between the silanols and the phosphate groups present in the polymer.

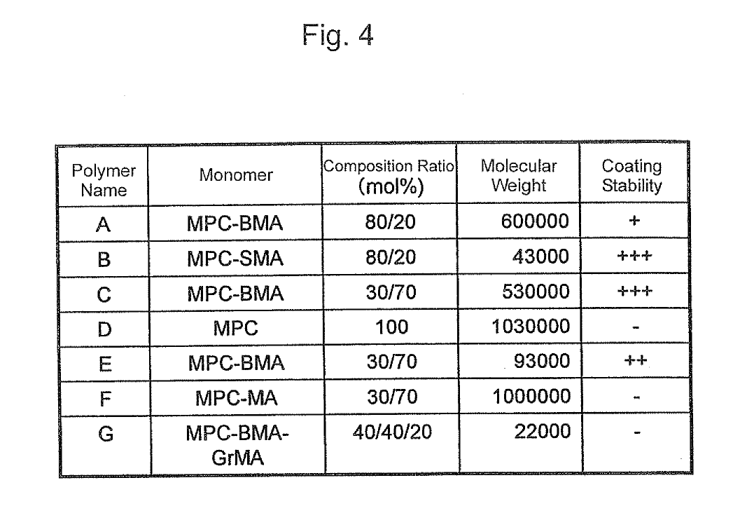

FIG. 4 illustrates phospholipid polymer types A to G and test results. In FIG. 4, MA represents methacrylate and GrMA represents glycerolmethacrylate.

From FIG. 4, it can be seen that the monomer forming the basic skeleton that is combined with MPC: (1) may have a small molecular weight as long as it has a certain level or more of hydrophobicity, although if it does not have a hydrophilic group, then such a monomer cannot be used even if it has a large molecular weight (Polymers B, D, and E); (2) for a hydrophobicity about the level of BMA, the molecular weight is important (Polymers C and E); and (3) for a hydrophobicity about the level of BMA, the composition ratio is also important (Polymers A and C).

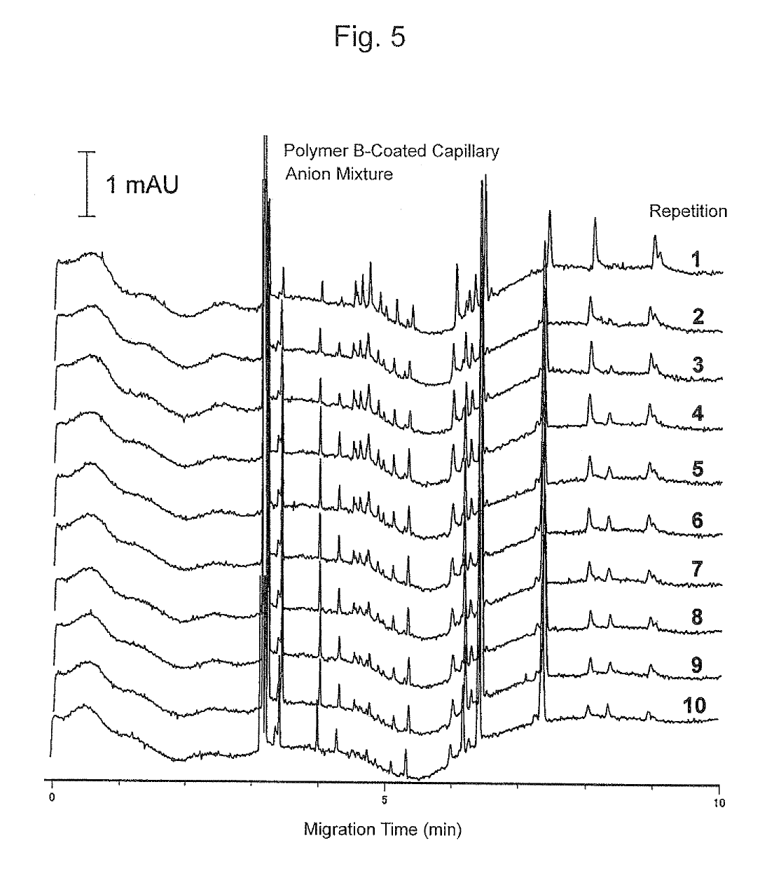

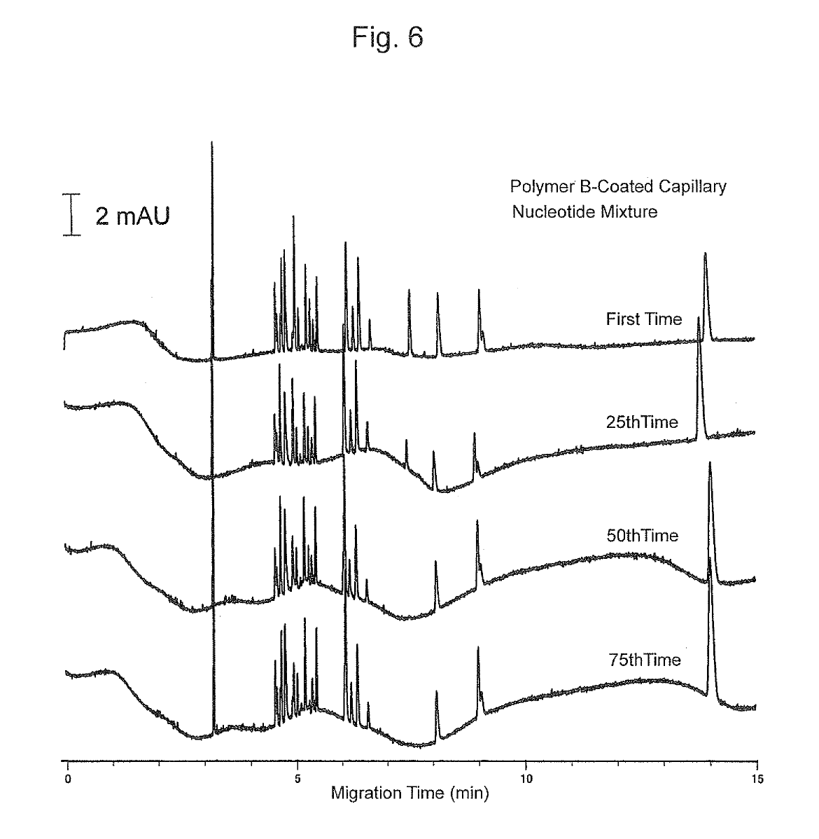

FIG. 5 illustrates the analysis results of an anion mixture by a polymer B-coated capillary. FIG. 6 illustrates the analysis results of a nucleotide mixture by the polymer B-coated capillary. The analysis conditions in FIG. 5 were a 50 cm capillary length, a 50 mM ammonium acetate separation solution, a pH of 7.4, an applied voltage of −30 kV, injection time of 3 seconds at 50 mbar, a 100 μM sample, and detection carried out at 214 nm. The analysis conditions in FIG. 6 were, except for the sample being 50 μM, the same as in FIG. 5.

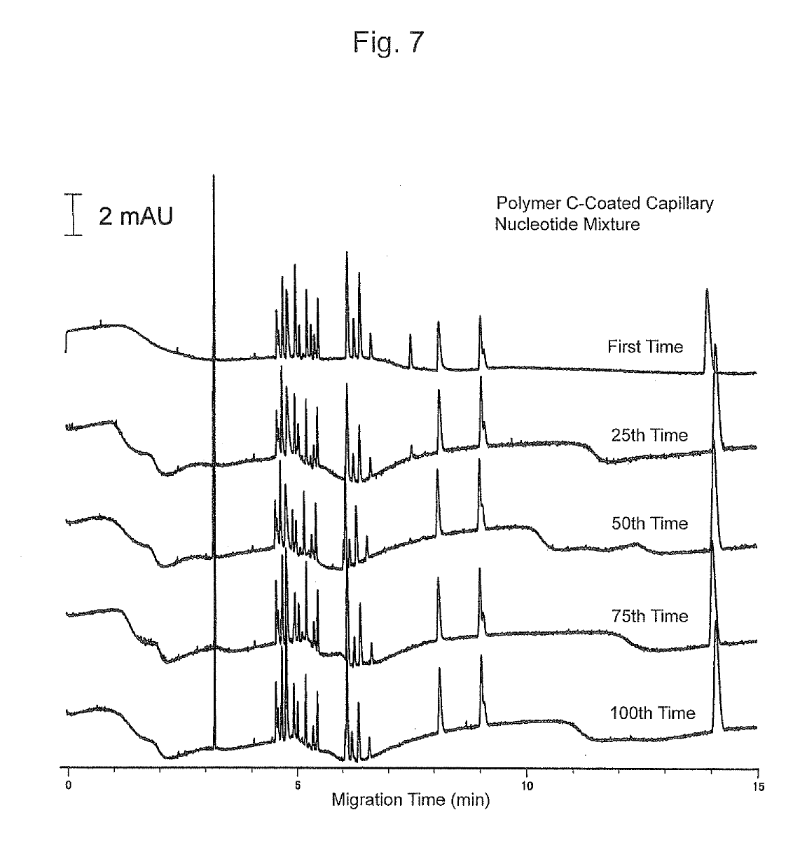

Further, FIG. 7 illustrates the analysis results of a nucleotide mixture by the polymer B-coated capillary. The analysis conditions in FIG. 7 are the same as in FIG. 6.

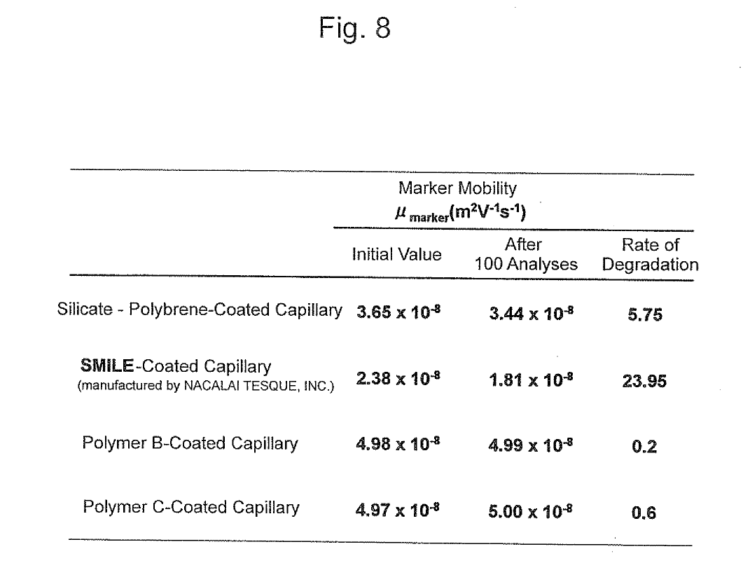

FIG. 8 illustrates the results of a comparison of the stability of various capillaries. The analysis conditions for the silicate-polybrene-coated capillary and the SMILE-coated capillary were a capillary total length of 38.5 cm, an effective length of 30 cm, a 50 mM ammonium acetate separation solution, a pH of 8.5, an applied voltage of −15 kV, detection carried out at 200 nm, a formamide EOF marker, and washing for 3 minutes (930 mbar) with the separation solution for each analysis. The analysis conditions for the polymer B-coated capillary and the polymer C-coated capillary were a capillary total length of 58.5 cm, an effective length of 50 cm, a 50 mM ammonium acetate separation solution, a pH of 7.4, an applied voltage of −30 kV, detection carried out at 214 nm, a trimeric acid EOF marker, and washing for 3 minutes (930 mbar) with the separation solution for each analysis.

The marker mobility μmarker and the rate of degradation were calculated on the basis of the following formulae.

μmarker=IL/Vt (1)

Here, I represents the effective length, L represents the total length, V represents the applied voltage, and t represents the movement time.

Rate of degradation=(|(μmarkerᵢₙᵢₜᵢₐₗ−μmarker_{runX})|/ μmarkerᵢₙᵢₜᵢₐₗ)×100% (2)

It can thus be seen that the capillary according to the present invention has a very small rate of degradation, and excellent stability.

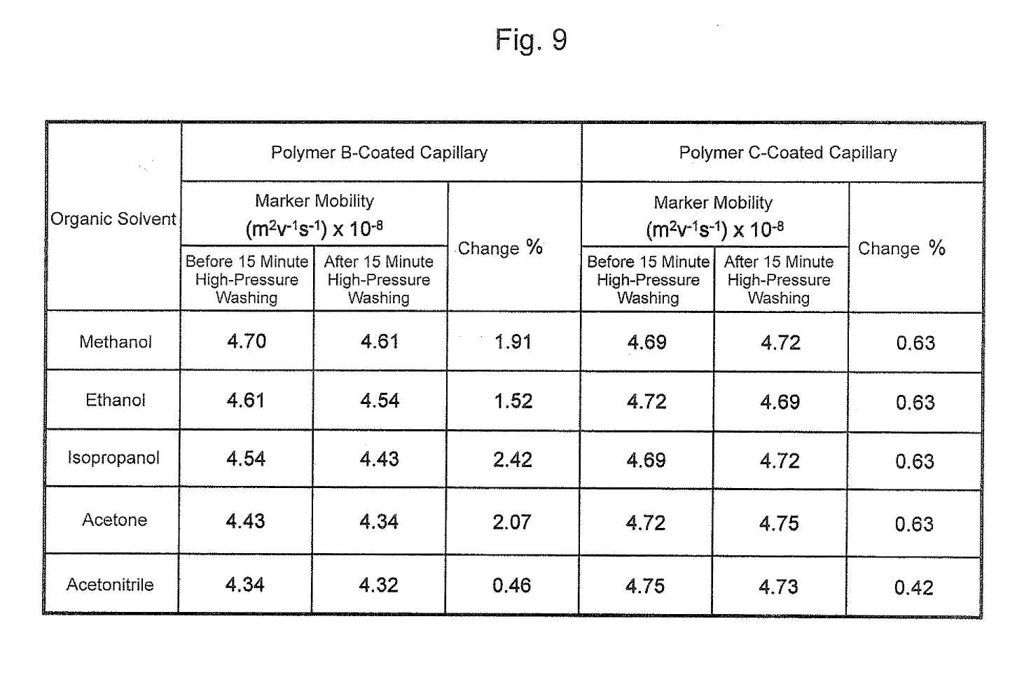

FIG. 9 illustrates the durability against organic solvents. The analysis conditions were a capillary total length of 58.5 cm, an effective length of 50 cm, an inner diameter of 50 a 50 mM ammonium acetate separation solution, a pH of 7.4, an applied voltage of −30 kV, and a trimesic acid EOF marker.

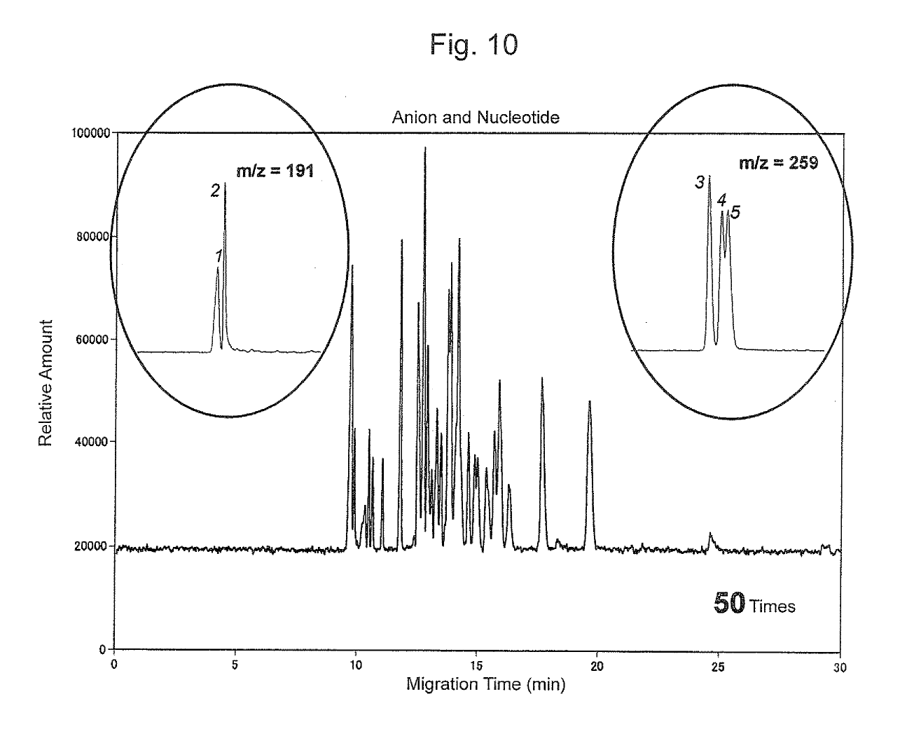

FIG. 10 illustrates the analysis results of a mixture containing an anion and a nucleotide by the polymer B-coated capillary. The analysis conditions were a capillary length of 100 cm, a 50 mM ammonium acetate separation solution, a pH of 7.4, an applied voltage of −30 kV, a sample injection time of 30 seconds at 50 mbar, and detection peaks at 1: isocitrate, 2: citrate, 3: glucose 1-phosphate, 4: fructose 6-phosphate, and 5: glucose 6-phosphate.

Conventionally, in metabolome analysis using CE-MS, phosphorylated compound analysis could not be performed under anion analysis conditions, due to adsorption onto the capillary. Consequently, it was necessary to provide a separate method. However, according to the present invention, as illustrated in FIG. 10, phosphorylated compound analysis such as nucleotide analysis and anion analysis can be simultaneously performed. Further, it was confirmed that even CoA, acetyl CoA, and malonyl CoA, which was reported in Soga et al., Anal. Chem., 2002, 74, 2233-2239 could not be measured due to adsorption by a SMILE-coated capillary, could be measured by the polymer B-coated capillary. In addition, an improvement in the separation efficiency itself was also seen due to the interaction between the wall surface and the solute being minimized.

Thus, in metabolome analysis using CE-MS, analysis that conventionally required two kinds of method to be used can be carried out using just one analysis method according to the present invention.

Further, in the above embodiment, although the present invention was applied to an inner-wall-coated capillary, the object of the invention is not limited to this. The present invention can also be applied to preventing adsorption in a beaker, a test apparatus and the like.

Moreover, the phospholipid polymer is not limited to a combination of MPC and BMA or MPC and SMA, as long as the amphoteric ionic polymer that is lipid-soluble.

### INDUSTRIAL APPLICABILITY

The present invention can provide an adsorption prevention method that is highly durable and that can simply prevent adsorption of a phosphorylated compound on an inner wall of a fused silica capillary tube used in capillary electrophoresis and the like, an adsorption prevention material, an inner-wall-coated capillary that has been subjected to an adsorption prevention treatment, a manufacturing method thereof, and a method for simultaneous analysis of a phosphorylated compound and anion that uses the above inner-wall-coated capillary.

1. An adsorption prevention method of inner-wall-coated capillary for capillary electrophoresis, comprising preventing adsorption of a phosphorylated compound using an amphoteric ionic polymer that is lipid-soluble.

2. The adsorption prevention method of inner-wall-coated capillary for capillary electrophoresis according to claim 1, wherein the polymer is a phospholipid polymer.

3. The adsorption prevention method of inner-wall-coated capillary for capillary electrophoresis according to claim 2, wherein the phospholipid polymer is a combination of MPC and SMA or MPC and BMA.

4-6. (canceled)

7. An inner-wall-coated capillary for capillary electrophoresis, comprising an amphoteric ionic polymer that is lipid-soluble is fixed to a wall surface by ionic interaction.

8. The inner-wall-coated capillary for capillary electrophoresis according to claim 7, wherein the polymer is a phospholipid polymer.

9. The inner-wall-coated capillary for capillary electrophoresis according to claim 8, wherein the phospholipid polymer is a combination of MPC and SMA or MPC and BMA.

10. The inner-wall-coated capillary for capillary electrophoresis according to claim 7, wherein the wall surface includes silanol.

11. A method for manufacturing an inner-wall-coated capillary for capillary electrophoresis, comprising only flowing a polymer solution including an amphoteric ionic polymer that is lipid-soluble through a capillary to fix the polymer to a wall surface by ionic interaction.

12. The method for manufacturing an inner-wall-coated capillary for capillary electrophoresis according to claim 11, wherein the polymer is a phospholipid polymer.

13. The method for manufacturing an inner-wall-coated capillary for capillary electrophoresis according to claim 12, wherein the phospholipid polymer is a combination of MPC and SMA or MPC and BMA.

14. The method for manufacturing an inner-wall-coated capillary for capillary electrophoresis according to claim 11, wherein the wall surface includes silanol.

15. A method for simultaneous analysis of a phosphorylated compound and anion by capillary electrophoresis, comprising using an inner-wall-coated capillary for capillary electrophoresis in which an amphoteric ionic polymer that is lipid-soluble is fixed to a wall surface by ionic interaction.

16. The method for simultaneous analysis of a phosphorylated compound and anion by capillary electrophoresis according to claim 15, wherein the polymer is a phospholipid polymer.

17. The method for simultaneous analysis of a phosphorylated compound and anion by capillary electrophoresis according to claim 16, wherein the phospholipid polymer is a combination of MPC and SMA or MPC and BMA.

18. The method for simultaneous analysis of a phosphorylated compound and anion by capillary electrophoresis according to claim 15, wherein the wall surface includes silanol.
